(19) United States
(12) Patent Application Publication
(10) Pub. No.: US 2005/0077282 A1
(43) Pub. Date: Apr. 14, 2005

(54) Container with vented blown finish

(75) Inventors: Gilles Keller, Amberieu en Bugey (FR); Brice Arlaud, Lyon (FR)

Correspondence Address: VENABLE, BAETJER, HOWARD AND CIVILETTI, LLP, P.O. BOX 34385, WASHINGTON, DC, 20043-9998, US

(73) Assignee: Graham Packaging Company, L.P., York, PA (US)

(21) Appl. No.: 10/682,925

(22) Filed: Oct. 14, 2003

(51) Int. Cl. F27D 11/00

(52) U.S. Cl. 219/401

(57) ABSTRACT

A container with a neck having a protrusion adapted to engage a sealing lid when the lid is placed on the container. The sealing ring or protrusion has a discontinuity, forming a gap when the lid is engaged on the container. The gap allows gas to escape during heating of product within the container when the lid is engaged.

### BACKGROUND OF THE INVENTION

1. Field of the Invention

The present invention relates generally to resealable containers, and more particularly to resealable, heatable, vented containers for containing and heating food.

2. Related Art

Foods packaged into single-serve containers have become commonplace. The advent and popularity of plastic containers for single-serve use has been prolific. Certain food products require heating, and the use of a microwave oven for heating single servings of prepared foods has become routine, as today's hectic lifestyle often leaves little time for preparing fresh meals. Plastic containers are ideal for microwave heating of food because plastic is compatible with microwave radiation, can withstand heat, does not easily break, and is cost-appropriate for containers that are used once and thrown away.

It is necessary that microwavable plastic containers have a mechanism to allow gas to escape during the heating process. Without such a feature, the container can rupture or explode, or the top of a sealed container can be damaged from pressure created during the heating process.

Containers for heating food preferably have resealable closures. Resealable closures are desirable because they allow the closure to be replaced on the container if all of the container contents have not been used. As a practical matter, contents often must be stirred or checked during the heating process, and the lid returned to resume heating. A resealable lid makes this process much easier. Another advantage of resealability is the ability to reheat contents and to reuse the container. Thus, such containers can contain more than a single use amount of material, resulting in decreased packaging costs.

There is a continuing need to develop suitable containers to meet all the purposes stated above.

Two common and well known types of resealable closures are threaded closures and friction fit or snap-fit closures. Threaded closures have been in existence for many years. In a threaded closure, a finish on the container, for example at the neck of a container, has external threads. A cap, or closure, is adapted to engage the threads of the finish for attachment to the container. This can be, for example, a projection in the closure or matching threads or a corresponding interior surface of the closure. In a friction fit or snap-fit closure system, the finish comprises an externally projecting ring that engages an inward facing projection on the closure. When the closure is forced onto the finish, the inward-facing ring on the closure is forced to a position below the externally projecting ring on the finish. As a result, the closure stays on the container unless sufficient force is applied to push the inward-facing ring back over the externally projecting ring on the finish. This arrangement, which requires the use of resilient material for the externally projecting ring on the finish and/or the inward facing ring on the closure, has been facilitated by the use of plastic bottles.

These two closure systems suffer several drawbacks, particularly when used with products intended to be heated inside the container, for example, in a microwave oven. These closure systems may require two hands to open and reseal the container. Furthermore, a larger size lid would be difficult to twist open, especially for individuals with smaller hands whose fingers cannot extend to the sides of the lid. A snap fit closure can be difficult to open because it requires getting ones fingers beneath the skirt. This often results in pinched fingers or broken nails.

Currently available heatable containers often have holes in the lid to allow steam to escape during the heating process. However, food particles can also escape, resulting in food splatter or content spillover. If venting is not sufficient, however, the container can explode or the lid be forced off during heating due to increased pressure within the container, created by steam from the heating process. Further, holes in the lid can lead to spoilage or degradation if the food or other product is stored in the container after the first heating. The holes allow air exchange, which can contaminate the contents in between uses.

Threaded closures are usually embodied as plastic bottles with twist lids for tight seals, such that no liquid or gas can escape. Vents are present in threaded closures for plastic bottles containing carbonated beverages, but gas is released only when the lid is loosened. Such a twist mechanism would be impractical in a single-serve container used for heating a product because the size of many food storage containers and lids precludes easy twisting. Also, the stability of a loose lid during the heating process is questionable.

Many food storage containers employ the snap-fit closure with a flexible lid that requires grasping beneath the lid skirt and pulling in order to remove the lid. Most plastic containers with threaded or snap-fit closures are not suitable for heating, as they have no venting system and the plastic is not heat-proof.

What is needed then is a container with vents that allows for heating of food products without food splatter, spill, or damage to the container and its contents. There is also a need for a container with an easily removable lid that is inexpensive to manufacture. There a further need for a resealable lid that prevents air exchange between uses.

### BRIEF SUMMARY OF THE INVENTION

In summary, the present invention provides for a heat-proof container with steam vents that allows for heating of food products without food splatter, spill-over or damage to the container and/or contents. The containers can also be resealable.

The present invention differs from prior art modifications which were not previously known or suggested. Most venting systems for heatable containers have holes or perforations in the lid. The present invention improves upon the prior art by devising a system in which steam can escape from vents around the finish. The venting system prevents the container from exploding and the contents from splattering or spilling over by allowing steam to escape during the heating process, yet is resealable in a manner that restricts air exchange during storage between uses. Furthermore, the lid is easily removable, as it provides a depression that facilitates grasping beneath the lid.

The present invention is a resealable, vented, heat-proof container that includes a neck having a finish. The mechanism for venting is located around the finish. The invention can also include a lid with a skirt extending from a planar top surface, and a sealing ring along the inner surface of the skirt. The lid can be engaged with the container during heating. Additionally, the system can have a means for easy removal of a lid.

The neck has a protrusion along the neck periphery which engages the sealing ring of a lid when a lid is placed on the container The protrusion can have a discontinuity that creates a gap when a lid is placed on the container. This gap allows air to escape during the heating process. Alternatively, the protrusion can be continuous and the sealing ring along the lid can have a discontinuity. In this arrangement, the discontinuity in the sealing ring creates the gap which allows air to escape during the heating process. For ease in opening, the container can also include a depression below the lid, allowing the user to grasp beneath the lid, facilitating removal.

The container also has a base and a body. A side wall is connected to the neck, and a base is connected to the side wall, creating an inner cavity capable of containing a product. The container can have ridges along the side wall for gripping. Furthermore, the container can be any shape including cylindrical, rectangular, and elliptical. The container can be used for heating and storing various food products such as cheese, sauces, pastas, noodles, rice, grains, meats, vegetables, nuts, fruit, and legumes.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 is an exploded, perspective view of an embodiment of the invention, illustrating the lid and the container;

FIG. 2 depicts a top view of the container in the embodiment of FIG. 1;

FIG. 3 depicts a side view of an exemplary embodiment according to the present invention;

FIG. 4 depicts a cross sectional view of the embodiment of FIG. 3 taken along line IV-IV when a lid is engaged.

FIG. 5 depicts a cross sectional view of the embodiment of FIG. 3 taken along line V-V when a lid is engaged.

FIG. 6 depicts a cross sectional view of the embodiment of FIG. 3 taken along line V-V when a lid is engaged during heating.

FIG. 7 depicts an interior view of a lid in a preferred embodiment of the claimed invention.

FIG. 8 is a cross sectional view of the lid of FIG. 6 taken along line VI-VI according to an exemplary embodiment of the present invention.

FIG. 9 depicts a front view of a preferred embodiment of the container according to the present invention.

### DETAILED DESCRIPTION OF THE INVENTION

A preferred embodiment of the invention is discussed in detail below. While specific exemplary embodiments are discussed, it should be understood that this is done for illustration purposes only. A person skilled in the relevant art will recognize that other components and configurations can be used without parting from the scope of the invention. In describing embodiments, specific terminology is employed for the sake of clarity. However, the invention is not intended to be limited by the specific terminology so selected.

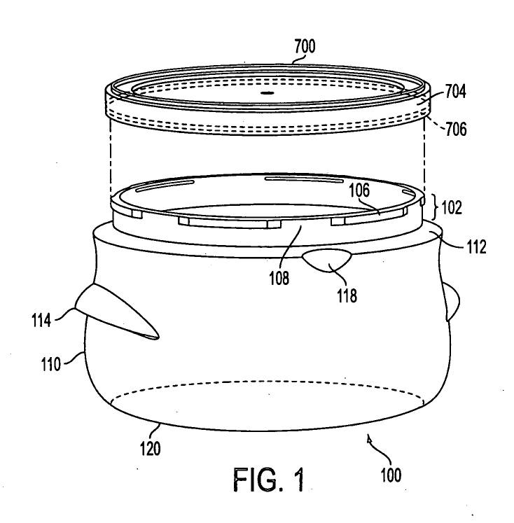

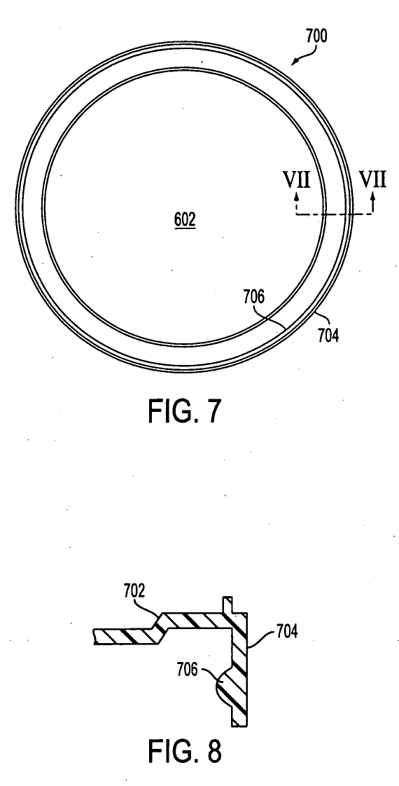

As depicted in the exemplary embodiment shown in FIG. 1, the present invention is a resealable container 100 that includes a neck 102 with a finish 104 that includes a radially extending protrusion 106 having a discontinuity 108. The protrusion 106 with discontinuity 108 is along the periphery of the neck 102. The protrusion 106 is adapted to engage the sealing ring 706 of a lid 700. FIG. 1 illustrates how the lid 700 fits over the neck 102 of the container 100 so that the two are engaged. The diameter of the lid skirt 704 is slightly larger than the diameter of the container neck 102 so that the skirt 704 can fit snugly over the neck 102. A sealing ring 706 along the interior of the lid (see FIG. 7) interacts with the protrusions 106 along the neck 102, sealing the container 100 when the lid 700 is engaged.

When the lid is engaged on the container 100, the discontinuity 108 creates a gap between the container 100 and the lid 700, resulting in a vent that allows steam generated during the heating process to escape. In an alternative embodiment, there can be a discontinuity present in the sealing ring of the lid, and the protrusion can be entirely continuous. In this arrangement, it is the discontinuity in the sealing ring that creates the vent through which hot air or gases can escape.

In the illustrated embodiment, the neck 102 is connected to the side wall 110 through the shoulder 112. The shoulder 112 slopes outwardly from the bottom of the neck 102 to the top of the side wall 110 resulting in a ledge-like structure that defines the shoulder 112. Thus the neck 102 is more narrow than the top-most portion of the side wall 110. This is merely a design option and is not required to practice the invention. A depression 118 can be present in the shoulder 112. The depression 118 provides a gap in the shoulder 112 that allows access to the bottom of the lid 700 to facilitate removal; for example, by allowing the user to grasp beneath the lid with a finger when the lid is engaged to facilitate removal. The depression 118 can exist anywhere along the shoulder, or can be absent entirely.

Ridges 114 can be present along the side wall 110 to allow a user to easily grip the container 100. In the illustrated embodiment there are two equally spaced ridges in the side wall 110, but other embodiments can have a greater or fewer number of ridges spaced anywhere along the side wall, or none at all. The ridges, by being raised and projecting away from the side wall 110, can maintain a cooler temperature or cool more quickly than the rest of the container 100, and can allow a user to hold the container 100 after heating without burning one's fingers.

The container 100 has a base 120 at the bottom, connected to the side wall 110. The base 120 can be concave, as shown, resulting in a standing ring along the periphery of the base 120. The concavity allows room for some container expansion during heating. Further, containers having flat bottoms are difficult to manufacture without wobbling.

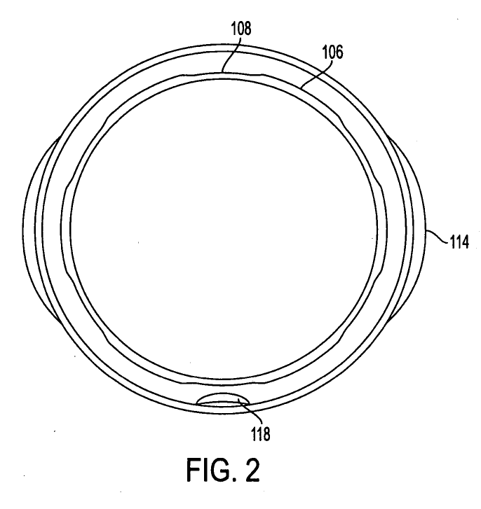

FIG. 2 is top view of the embodiment of the container of FIG. 1. The illustrated embodiment utilizes 6 protrusions with 6 discontinuities, creating 6 vents for steam to escape. The placement of the ridges 114, being on opposite sides of the container 100 is apparent. The depression 118 is also visible.

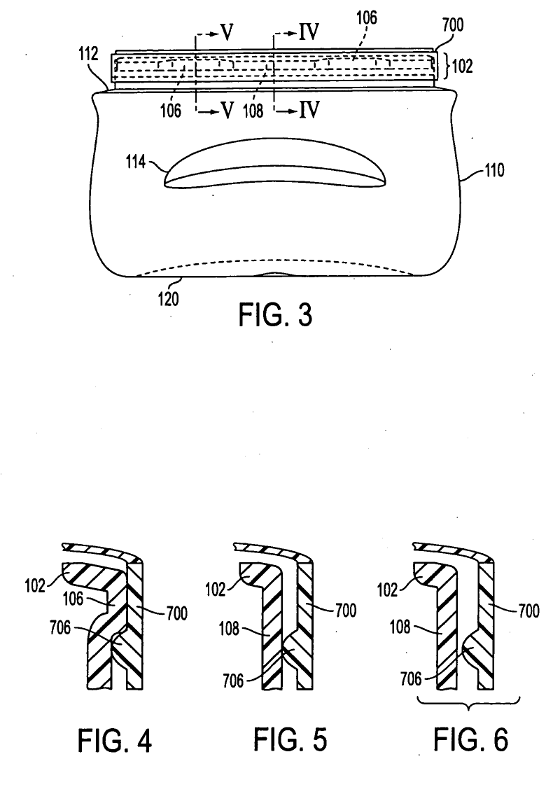

FIG. 3 is a side view of an exemplary embodiment of the invention with a lid 700 engaged thereon. Again, the neck 102, finish 104, shoulder 112, side wall 110 with ridges 114, and base 120 are visible. The design of the ridge 114 is clearly shown.

FIG. 4 is an enlarged, cross sectional view taken along line IV-IV in FIG. 3, extending through the protrusion 106. Thus the portion of the container 100 that is represented is the protrusion 106 along the neck of the container 100. A cross section of the lid 700 is also shown, with the sealing ring 706 engaged with the protrusion 106.

FIG. 5 is an enlarged, cross sectional view taken along line V-V of FIG. 3, extending through the region including the discontinuity 108 in protrusion 106. Again, a cross section of the lid is also shown. The space between the sealing ring 706 of the lid and the discontinuity 108 is the vent that is created when the lid is engaged on the container.

Several things can happen during heating when the container 100 and its contents are engaged with the lid 700. First, as the contents begin to increase in temperature, steam or other volatile gases can form or escape from the heated product in the container. As these gases form, the internal pressure within the container 100 increases. This can force the lid 700 in an upwards direction. However, because the sealing ring 706 engages the protrusion 106, the lid 700 is prevented from being forced off the container 100. As illustrated in FIG. 4, a seal is formed between the lid 700 and the container 100 by contact of the sealing ring 706 with the protrusion 106. In the absence of venting, pressure can develop in the container 100 that is sufficient to force the lid 700 off the container 100. According to the present invention, however, the discontinuities 106 provide an area for venting, as shown in FIG. 6. Notably, even if the sealing ring 706 were to contact the container 100, as pressure in the container 100 builds, the lid 700, formed of a resilient material, can distend to allow steam or other volatile gases to escape. If the protrusion 106 was continuous, the only way gas could escape would be by forcing the lid 700 off the container 100. The present invention thus provides for venting, while maintaining sufficient engagement of the lid and container to prevent the lid from being forced off the container.

FIG. 6 is an enlarged cross sectional view along line V-V of FIG. 3, extending through the region including the discontinuity 108 in protrusion 106, taken during heating of the container, lid, and contents. Steam created from the heating process, exiting through the vents, can cause a slight separation of the sealing ring from the container neck. This minor distension of lid 700 does not disturb the secure engagement of the lid 700 to the container 100.

FIG. 7 is an interior view of an exemplary embodiment of a lid 700 according to the invention. FIG. 8 is a cross sectional view taken along line VII-VII of FIG. 7. The lid 700 includes a substantially planar top surface 702 for covering the opening in the neck of the container. Extending from the top surface is a skirt 704 that has a diameter slightly larger than the neck of the container. A sealing ring 706 is formed on the inner surface of the skirt 704 and extends inward. The sealing ring 706 can be a continuous ring, or can be broken into smaller segments. The sealing ring 706 interacts with the protrusion 106 along the container neck periphery, sealing the container when the lid is engaged.

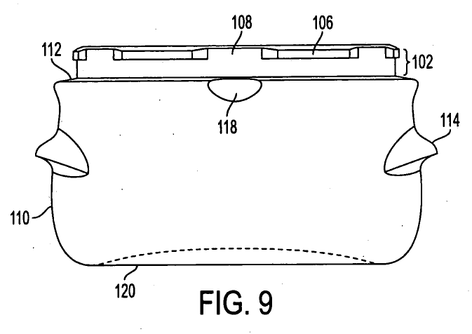

FIG. 9 is a front view of the container in an exemplary embodiment of the invention, illustrating the features of the container.

The closure system of the invention can take on various geometries. For convenience, the system has been shown and described as being substantially round in cross section, i.e. cylindrical. However, the invention is not limited to this shape. For example, the container according to the invention can be round, square, rectangular or elliptical in cross section. The container also be embodied in varying sizes and dimension.

Containers of the present invention can contain a variety of food products such as cheese, sauces, pastas, noodles, rice, grains, meats, vegetables, nuts, fruits, and legumes. After the container is filled, an air-tight seal can be placed over the mouth of the container, for example by gluing or welding. The air space above the product can be evacuated before sealing. Placing an air-tight seal over the container helps prevent the food or other product from spoilage or degradation during storage before use. The lid can then be placed over the sealed container. A shrink-wrap cover or other tamper-evident band can then be placed over the lid and top of the container.

When a consumer purchases the product, the tamper-evident band, if present, is removed, the lid taken off, and the air-tight seal removed and discarded. The lid is then placed back on the container and the container and its contents heated, for example in a microwave oven. During heating, the sealing ring on the lid engages the protrusion on the container to hold the lid on the container. As the product is heated, steam or other gas generated in the container can escape through the discontinuities in the protrusions.

The lid can be made by any suitable forming process, such as injection molding, and be made of any suitable polymer, for example, a polyolefin such as polyethylene or polypropylene. The container can be made by any suitable forming process. Examples of suitable processes include blow molding such as injection blow molding, stretch blow molding, and extrusion blow molding; injection molding; and thermoforming. The container can be made of any suitable plastic such as a polyester, including polyethylene terephthalate (PET) and polyethylene naphthalate (PEN); polyolefins such as polyethylene and polypropelene; and polyamides such as nylon. Furthermore, the container may be composed of a single layer or multilayer of suitable materials.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A container system, comprising:
a lid, comprising
a top surface;
a skirt extending from said surface; and
a sealing ring around an inner surface of said skirt; and
a container, comprising
a neck having a protrusion along a periphery of said neck, and said protrusion adapted to engage said sealing ring when said lid is placed on said container;
at least one of the sealing ring and the protrusion having a discontinuity forming a gap in said sealing ring or said protrusion;
wherein the container system allows gas to escape from within the container during heating of a product contained within the container when said lid is engaged on said container.

2. The system of claim 1, wherein said top surface is substantially planar.

3. The system of claim 1, wherein said sealing ring is continuous.

4. The system of claim 1, wherein said protrusion is continuous.

5. The system of claim 1, wherein said protrusion is along a rim of said neck of said container.

6. The system of claim 1, wherein said container further comprises:
a side wall connected to said neck; and
a base connected to said side wall;
wherein said side wall and said base are joined, creating an inner cavity capable of containing a product.

7. The system of claim 1, wherein the gas escapes from said system through a recess resulting from said discontinuity, when said lid is engaged on said container.

8. The system of claim 1, wherein said container further comprises two ridges extending from said side wall, for gripping said container, said ridges also being raised, defining a distance between said ridge and said side wall.

9. The system of claim 1, said container further comprising an indentation below the neck to facilitate removal of said lid.

10. The system of claim 1, wherein said lid comprises a single sealing ring.

11. A container comprising:
a neck having a protrusion along a periphery of said neck, and said protrusion adapted to engage a sealing ring on a lid when the lid is placed on said container;
at least one of the sealing ring and the protrusion having a discontinuity forming a gap in said sealing ring or said protrusion;
wherein the container allows gas to escape from within the container during heating of a product contained within the container when the lid is engaged on said container.

12. The container of claim 11, wherein said protrusion is along a rim of said neck of said container.

13. The container of claim 11, wherein said protrusion is continuous.

14. The container of claim 11, wherein the protrusion contains a discontinuity.

15. The container of claim 11, wherein said container further comprises:
a side wall connected to said neck; and
a base connected to said side wall;
wherein said side wall and said base are joined, creating an inner cavity capable of containing a product.

16. The container of claim 11, wherein the gas escapes from said system through a recess resulting from said discontinuity, when the lid is engaged on said container.

17. The container of claim 11, wherein said container further comprises two ridges extending from said side wall, for gripping said container, said ridges also being raised, defining a distance between said ridge and said side wall.

18. The container of claim 11, said container further comprising an indentation below the neck.

19. A method of containing a heatable product comprising placing said heatable product in a container that comprises:
a neck having a protrusion along a periphery of said neck, and said protrusion adapted to engage a sealing ring on a lid when the lid is placed on said container;
at least one of the sealing ring and the protrusion having a discontinuity forming a gap in said sealing ring or said protrusion;
wherein the container allows gas to escape from within the container during heating of a product contained within the container when the lid is engaged on said container.

20. The method of claim 19, wherein said sealing ring is continuous.

21. The method of claim 19, wherein said protrusion is continuous.

22. The method of claim 19, further comprising placing a lid on said container, said lid comprising:
a top surface;
a skirt extending from said surface; and
a sealing ring around an inner surface of said skirt.

23. The method of claim 22, wherein said top surface is substantially planar.

24. The method of claim 19, wherein said product is selected from cheese, sauces, pastas, noodles, rice, grains, meats, vegetables, nuts, fruits, and legumes.
